(19) United States
(12) Patent Application Publication
(10) Pub. No.: US 2015/0013776 A1
(43) Pub. Date: Jan. 15, 2015

(54) Regulating Valve

(71) Applicant: Cyltex, Limited Liability Company, Houston, TX (US)

(72) Inventor: Daniel A. Lammers, Fenton, MO (US)

(21) Appl. No.: 13/941,722

(22) Filed: Jul. 15, 2013

(51) Int. Cl. G05D 16/10

(52) U.S. Cl. CPC G05D 16/106
USPC 137/14; 137/505

(57) ABSTRACT

A regulating valve includes a regulating-valve-high-pressure connector, a regulating-valve-low-pressure connector, and a regulating-valve-pressure-reducing device. The regulating-valve-pressure-reducing device includes a regulating-valve-high-pressure chamber coupled to the regulating-valve-high-pressure connector, a regulating-valve-low-pressure chamber coupled to the regulating-valve-low-pressure connector, and a regulating-valve-high-pressure regulator coupled to the regulating-valve-high-pressure chamber and the regulating-valve-low-pressure chamber to maintain the regulating-valve-low-pressure chamber at a constant pressure. The regulating valve further includes a pressure gauge coupled to the regulating-valve-low-pressure chamber.

### BACKGROUND

Gas monitors, which are used to detect the presence of, typically, trace amounts of gases are calibrated and verified for proper function using calibration gases provided in high pressure cylinders. The calibration gases contain precise amounts of gases to be detected such as hydrogen sulfide (H2S), carbon monoxide (CO), combustibles etc. The high pressure cylinder typically accepts a valve to fill, contain, and release the pressurized gas in the cylinder. The outlet of this valve typically has a standard thread. One example is a ⅝″-18 UNF-2B thread commonly referred to as a C-10 valve. In order to get the gas out of the cylinder a regulator is used open the valve. Continuing with the example just mentioned, the regulator has a complimentary thread of ⅝-18 UNF-2A on its inlet so it can be threaded on to the C-10 valve outlet. The regulator also serves to reduce the pressure from the maximum cylinder fill pressure, for example from 1000 psig to a usable pressure of around 60 psig or less. The regulator typically will also have an orifice downstream of the regulating mechanism that will deliver the gas at a constant flow rate required by the gas monitor.

Historically, the gas cylinders have not been filled above 1000 psig for this particular application. The pressure reducing regulators in the field that have been supplied to work with these cylinders are also rated for a maximum inlet pressure of no more than 1000 psig and include a gauge with a maximum reading of 1,000 psig. The connection from the gas detector to the pressure cylinder via the C-10 valve and the regulator has become the defacto standard of the industry. This arrangement has the consequence of limiting the cylinder pressure to 1000 psig or below to prevent over pressurization of the regulators with the C-10 valve. Since the bottle and C-10 valve are capable of handling a higher pressure, the regulators already in the possession of the user could be accidently used on a higher pressure cylinder with the same complimentary thread of C-10, ⅝-18 UNF-2B thread.

Other examples exist in other applications where the defacto pressure is different but the same idea applies.

### BRIEF DESCRIPTION OF THE DRAWINGS

FIG. 1 illustrates a prior art configuration.

FIG. 2 illustrates a configuration with a regulating valve having a C10 connection.

FIGS. 3-5 illustrate configurations in which a regulator is integral with a regulating valve.

FIG. 6 illustrates a perspective view of a regulating valve.

FIG. 7 illustrates a cross-sectional view of a regulating valve.

FIG. 8 illustrates an exploded view of a regulating valve.

FIGS. 9-11 illustrate the flow of gas through a regulating valve.

FIGS. 12 and 13 illustrate the connection of a gauge to a regulating valve.

### DETAILED DESCRIPTION

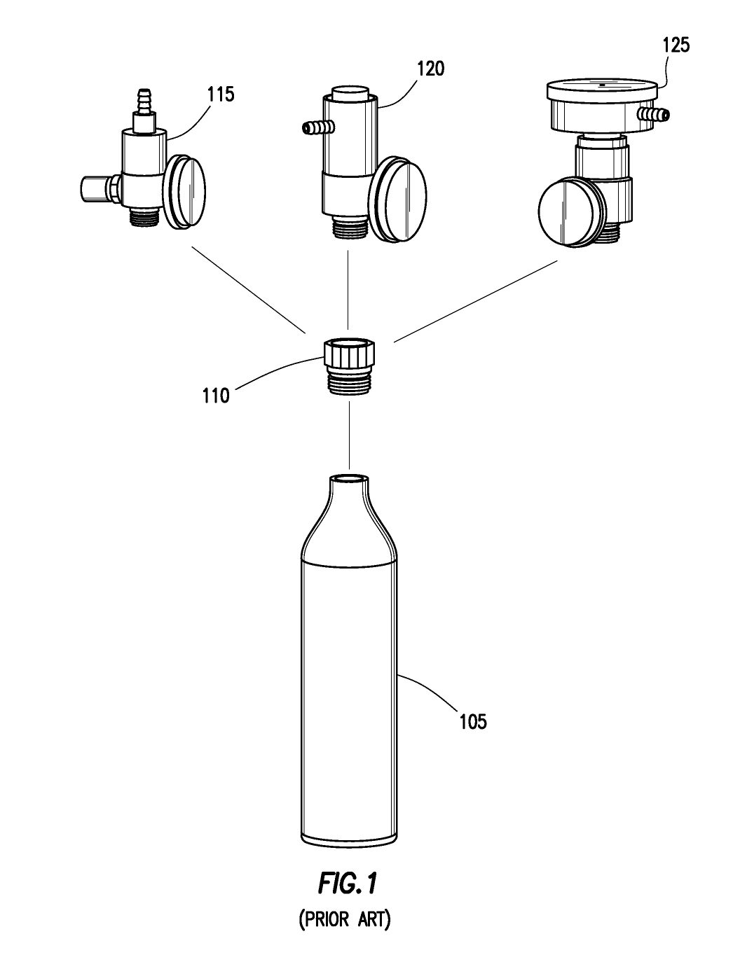

In a prior art configuration, illustrated in FIG. 1, a 1000 psi pressure bottle 105 is coupled to a standard C10 valve 110 that reduces pressure from 1000psi, the pressure in the pressure bottle 105 when it is new, to a usable pressure at around 20 psi. A regulator, such as on/off regulator 115, push button regulator 120, or demand flow regulator 125, is coupled to the C10 valve and provides the respective functions of providing gas flow controlled by an on/off valve, a push button regulator, or a demand flow regulator. Because the C10 valve is limited on the high-pressure side to 1000 psi, the pressure vessel is limited to 1000 psi or below. Further, each of the regulators 115, 120, and 125 includes a gauge which displays the pressure on the low-pressure side of the C10 valve. Users have become accustomed to watching this pressure and knowing that when it falls below 1000 psi it is time to purchase a replacement pressure bottle.

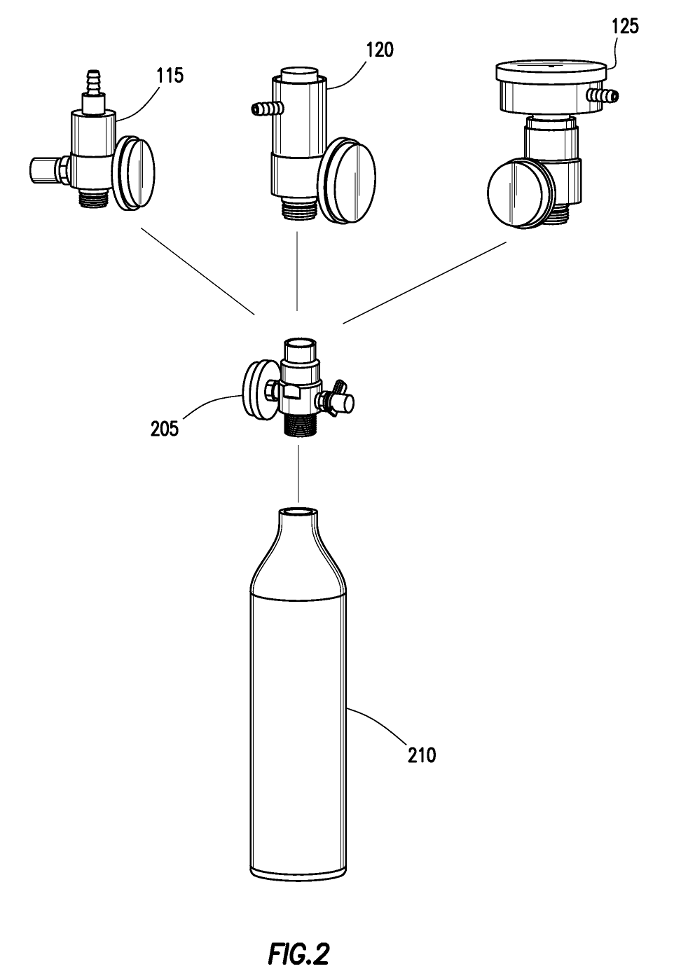

In one embodiment, illustrated in FIG. 2, a regulating C10 valve 205 includes a pressure regulator to allow greater than 1000 psi to be applied to the high-pressure side while still delivering a usable pressure of around 20 psi on the low-pressure side integrated with a connection equivalent to the low-pressure connector of a C10 valve on the low-pressure side (where “integrated with” means manufactured as a unit). In one embodiment, such a configuration allows the regulating C10 valve 205 to be connected to an 1800 psi pressure bottle 210 on the high-pressure side and to one of the commonly-available regulators 115, 120 or 125 on the low-pressure side. It will be understood that the pressure rating on the pressure bottle (1800 psi) 210 is merely an example and that the pressure rating can be higher or lower than 1800 psi. Indeed, pressure bottle (1800 psi) 210 can be replaced by pressure bottle (1000 psi) 105.

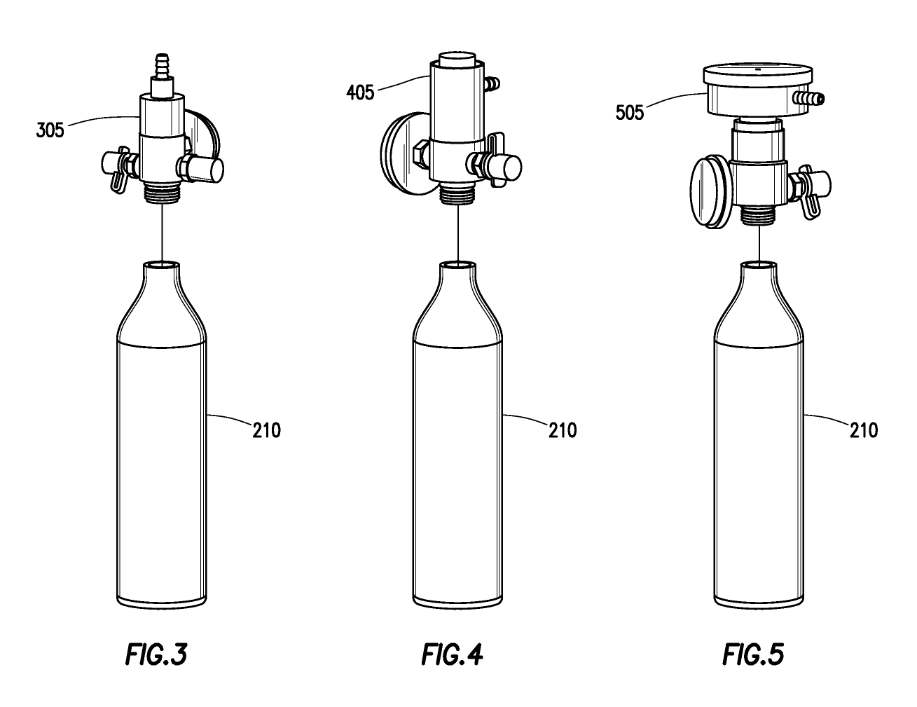

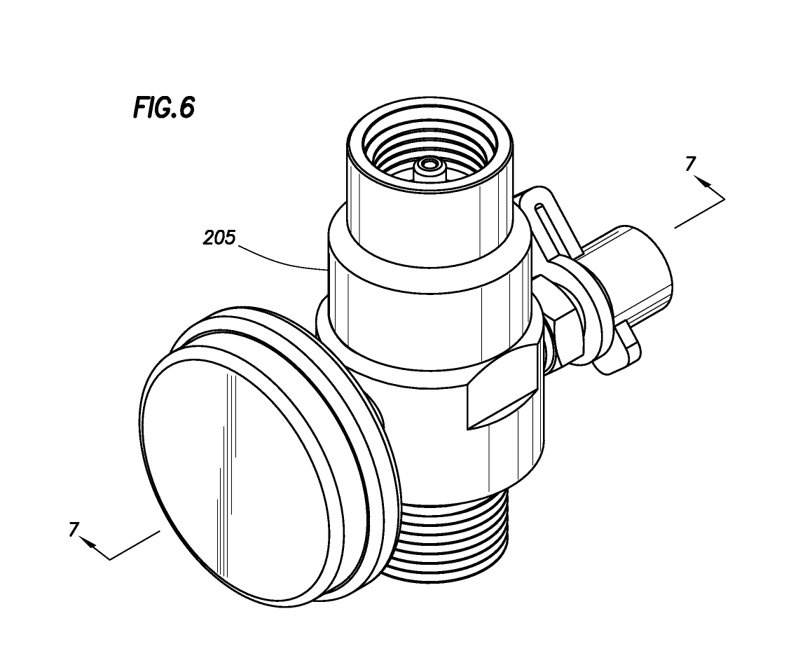

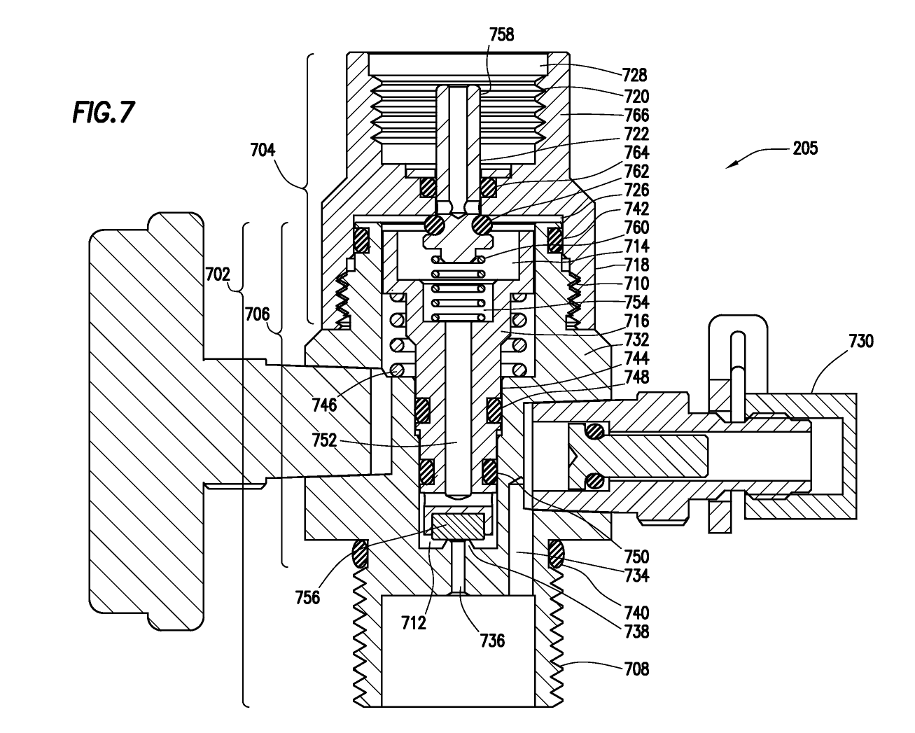

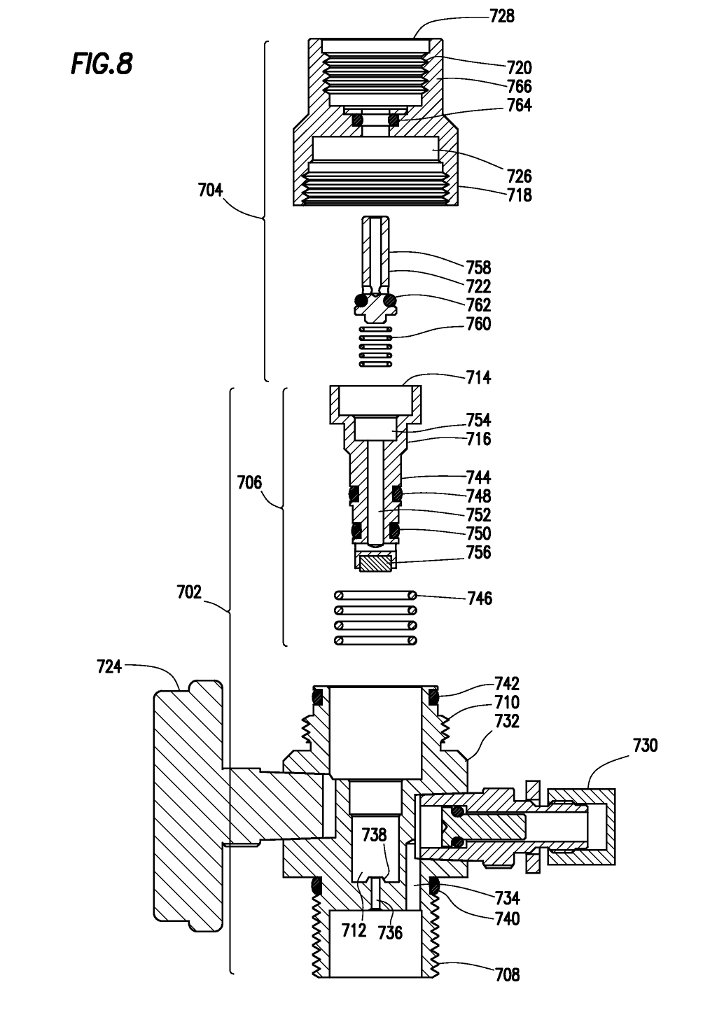

In one embodiment, illustrated in FIGS. 3-5, the regulators 115, 120 and 125 are integrated with the regulating C10 valve 205 to create an on/off knob regulator with a direct connection to pressure bottle 305, a push button regulator with a direct connection to pressure bottle 405, and a demand flow regulator with a direct connection to pressure bottle 505, all of which couple to the pressure bottle (1800 psi) 210.

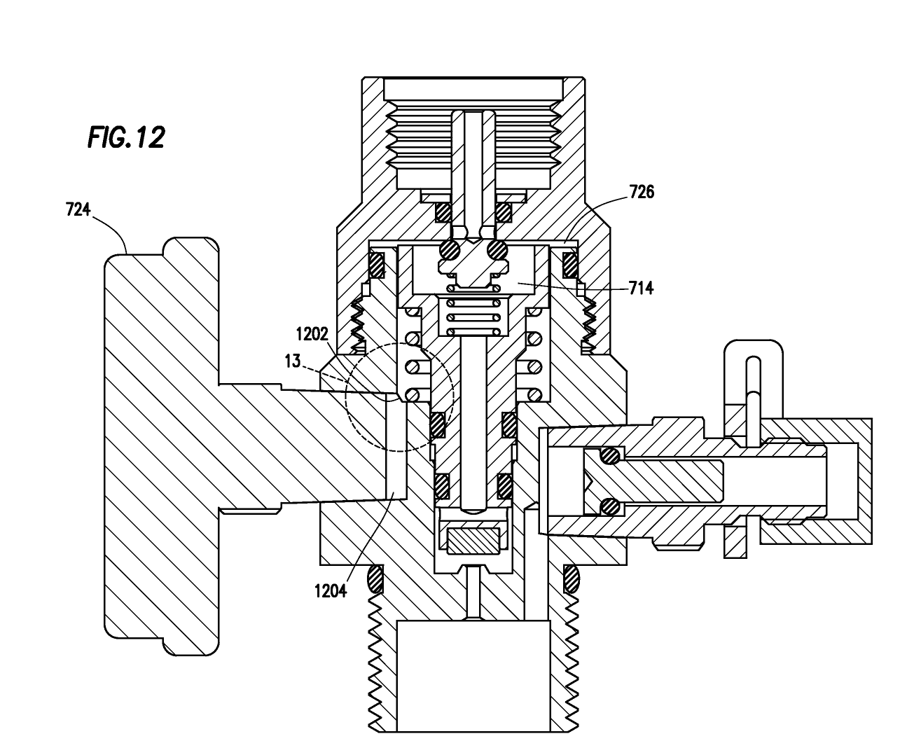

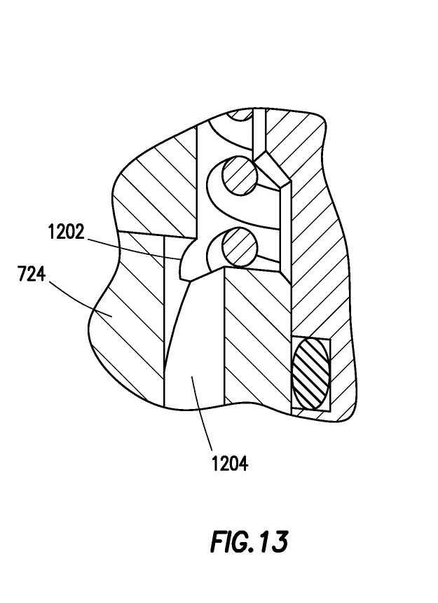

In one embodiment, illustrated in FIGS. 6 (in perspective view), 7 (in cross section), and 8 (in an exploded view), the regulating C10 valve 205 includes a regulating valve 702 and a flow control valve 704. The regulating valve 702 includes a regulating-valve-pressure-reducing device 706, a regulating-valve-high-pressure connector 708, and a regulating-valve-low-pressure connector 710. In one embodiment, the regulating-valve-pressure-reducing device 706 includes a regulating-valve-high-pressure chamber 712 coupled to the regulating-valve-high-pressure connector 708 and a regulating-valve-low-pressure chamber 714 coupled to the regulating-valve-low-pressure connector 710. In one embodiment, a regulating-valve-high-pressure regulator 716 is coupled to the regulating-valve-high-pressure chamber 712 and the regulating-valve-low-pressure chamber 714 to maintain the regulating-valve-low-pressure chamber 714 at a constant pressure. In one embodiment, a pressure gauge 724 is coupled to the regulating-valve-low-pressure chamber 714 as discussed below in connection with FIGS. 12 and 13.

In one embodiment, the flow control valve 704 includes a flow-control-valve-high-pressure connector 718 and a flow-control-valve-low-pressure connector 720. In one embodiment, the flow control valve 704 includes a flow-control-valve-low-pressure regulator 722 coupled to the flow-control-valve-high-pressure connector 718 and the flow-control-valve-low-pressure connector 720 to maintain the flow-control-valve-low-pressure connector 720 at a user pressure. In one embodiment, the flow-control-valve-high-pressure connector 718 is coupled to the regulating-valve-low-pressure connector 710. In one embodiment, this coupling creates a flow-control-valve-high-pressure chamber 726. In one embodiment, the flow control valve 704 includes a flow-control-valve-low-pressure chamber 728.

In one embodiment, a fill port 730 is attached to a regulating-valve body 732 that forms the primary body of the regulating valve 702. A fill passage 734 provides a passage from the fill port into open volume of the regulating-valve-high-pressure connector 708 that is connected to the pressure bottle (1800 psi) 210 in use. In one embodiment, a pressure passage 736 provides a passage from the open volume of the regulating-valve-high-pressure connector 708 to the regulating-valve-high-pressure chamber 712 through a main regulator seat 738, which is a conical feature at the base of the regulating-valve-high-pressure chamber 712. In one embodiment, a regulating-valve-high-pressure seal 740 seals the regulating-valve-high-pressure connector 708 and a regulating-valve-low-pressure seal 742 seals the regulating-valve-low-pressure connector 710.

In one embodiment, a regulator piston 744 fits through a regulator spring 746 into the regulating-valve body 732. In one embodiment, the regulator piston 744 includes an upper regulator seal 748 and a lower regulator seal 750. In one embodiment, when the regulator piston 744 is seated in the regulating-valve body 732 the upper regulator seal 748 presents a surface area (A1) to the regulating-valve-low-pressure chamber 714 that is greater than the surface area (A2) presented by the lower regulator seal 750 to the regulating-valve-high-pressure chamber 712, i.e., A1>A2. In one embodiment, a piston passage 752 extends through a longitudinal length of the regulator piston 744 and opens into a stepped chamber 754 having a first diameter where the piston passage 752 first opens and a larger diameter a distance away from that opening. In one embodiment, a portion of the stepped chamber 754 is coincident with the regulating-valve-low-pressure chamber 714. In one embodiment, the regulator piston 744 includes a main regulator seal 756 at the end opposite the stepped chamber 754.

In one embodiment the flow-control-valve-low-pressure regulator 722 includes a C10 stem 758. When assembled, in one embodiment, the C10 stem 758 compresses a C10 spring 760 against a base of the first diameter of the stepped chamber 754. A lower C10 seal 762 seals the flow-control-valve-high-pressure chamber 726 until the C10 stem 758 is pressed down compressing C10 spring 760. An upper C10 seal 764 seals the C10 stem 758 as it slides through the flow control valve body 766.

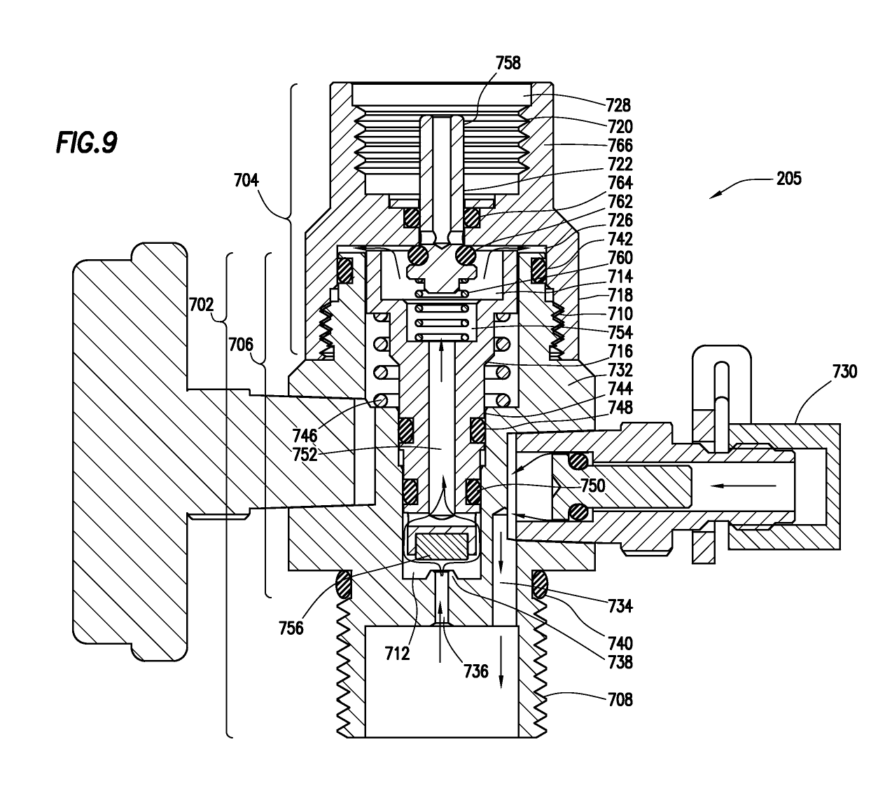

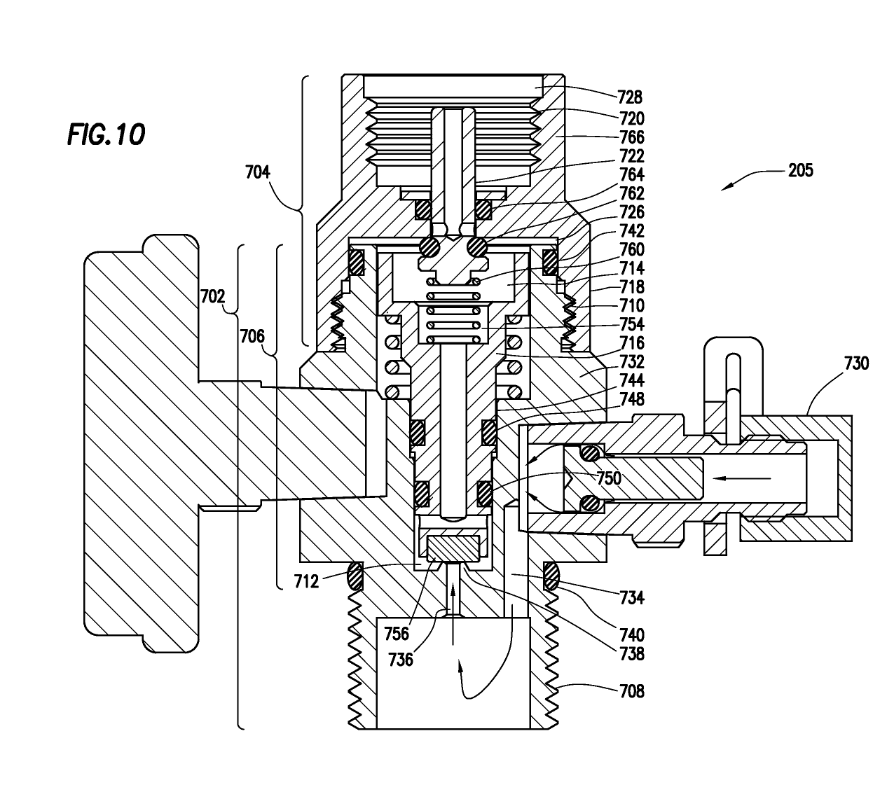

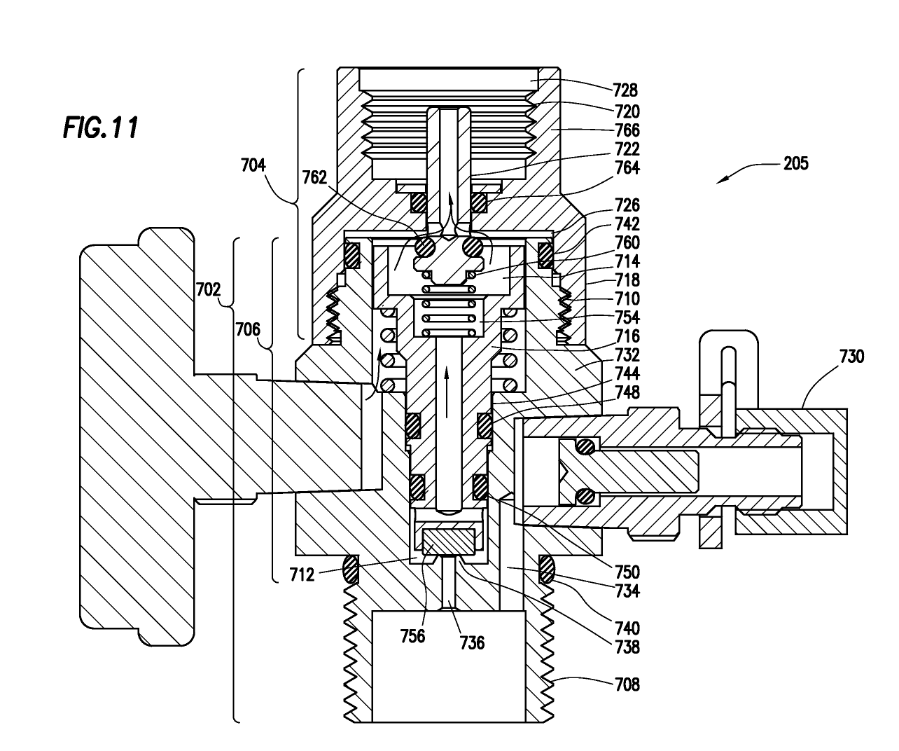

FIG. 9 illustrates one embodiment of the regulating C10 valve 205 when pressure is first applied. In one embodiment, gas pressure enters the regulating C10 valve 205 through the fill port 730. In one embodiment, the gas pressurizes through the fill passage 734, through the pressure passage 736 and the main regulator seat 738, around the main regulator seal 756 (the regulator piston 744 is initially in the open position allowing the gas to fill the valve), and into the regulating-valve-high-pressure chamber 712. In one embodiment, the gas pressurizes around the main regulator seal 756, through the piston passage 752, and into the regulating-valve-low-pressure chamber 714 and flow-control-valve-high-pressure chamber 726. In one embodiment, the C10 stem 758 is closed preventing gas from escaping from the regulating C10 valve 205. In one embodiment, as gas pressure is increased, the regulator piston 744 remains open until the pressure reaches the closing pressure (e.g., 900 psi). In one embodiment, as the pressure reaches the closing pressure, the regulator piston 744 starts to move down. The movement occurs because, in one embodiment, the force created at the upper regulator seal 748 (with surface area A1) is greater than the force created at the lower regulator seal 750 (with surface area A2). In one embodiment, since the pressure is the same at both seals, the larger area of the upper regulator seal 748 will cause the regulator piston 744 to move in the downward direction until the main regulator seal 756 contacts the main regulator seal 738, as shown in FIG. 10.

FIG. 10 shows one embodiment of the regulating C10 valve 205 in the closed position. The pressure below the main regulator seat 738 will continue to increase until the desired bottle pressure is reached (typically 1800 psi), however the pressure above the main regulator seat 238 (and in the regulating-valve-low-pressure chamber 714 and flow-control-valve-high-pressure chamber 726) will remain at the closing pressure (e.g., 900 psi). Even though the pressure above the regulator piston 744 is only at the closing pressure, the force that pressure creates remains strong enough to keep the regulator closed because it is acting over a larger area (i.e., the surface area A1 of the upper regulator seal 748 compared to the surface area A2 of the lower regulator seal 750).

FIG. 12 shows one embodiment of the C10 stem 758 being open allowing gas to flow out of the regulating C10 valve 205. In one embodiment, this occurs when a device is connected to the flow-control-valve-low-pressure connector 720 which causes the C10 stem 758 to be pushed down against the resistance of the C10 spring 760. In one embodiment, this causes the lower C10 seal 762 to become unsealed which allows the gas at closing pressure (e.g., 900 psi) to escape from the valve. In one embodiment, as the pressure in the regulating-valve-low-pressure chamber 714 and flow-control-valve-high-pressure chamber 726 drops below 900 psi in the valve, the regulator piston 744 will open to allow more gas into the regulating-valve-low-pressure chamber 714 and flow-control-valve-high-pressure chamber 726 re-pressurizing them to the closing pressure. In one embodiment, the regulating valve 702 will continue to regulate gas regulating-valve-low-pressure chamber 714 and flow-control-valve-high-pressure chamber 726 at the closing pressure as the C10 stem is opened and closed. In one embodiment, once the pressure in the bottle drops below 900 psi the regulator piston will remain open until the gas is emptied from the bottle.

In one embodiment, illustrated in FIGS. 12 (in cross-section) and 13 (a close-up plan view of the area highlighted by the dashed circle in FIG. 12), the pressure gauge 724 measures the gas pressure in the regulating-valve-low-pressure chamber 714 and flow-control-valve-high-pressure chamber 726. In one embodiment, a gauge port pressure hole 1202 allows gas from the regulating-valve-low-pressure chamber 714 and flow-control-valve-high-pressure chamber 726 to pressurize a gauge chamber 1204. In one embodiment, the gauge 724 measures the pressure in the gauge chamber 1204 and thus the regulating-valve-low-pressure chamber 714 and flow-control-valve-high-pressure chamber 726.

As a consequence, in one embodiment, the gauge 724 reflects the closing pressure (e.g., 900 psi) rather than the pressure in the bottle. In one embodiment, this eases the transition of users from the low pressure (i.e., 900 psi) pressure bottles to higher pressure (e.g., 1800 psi or even higher) bottles. Further, the gauge 724 reflects the same pressure (i.e., around 900 psi) until the pressure in the pressure bottle 210 falls below the closing pressure (e.g., 900 psi), at which time the user knows it is time to consider replacing the pressure bottle 210.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus comprising:
a regulating valve comprising:
a regulating-valve-high-pressure connector;
a regulating-valve-low-pressure connector, and a regulating-valve-pressure-reducing device comprising:
a regulating-valve-high-pressure chamber coupled to the regulating-valve-high-pressure connector,
a regulating-valve-low-pressure chamber coupled to the regulating-valve-low-pressure connector, and
a regulating-valve-high-pressure regulator coupled to the regulating-valve-high-pressure chamber and the regulating-valve-low-pressure chamber to maintain the regulating-valve-low-pressure chamber at a constant pressure; and
a pressure gauge coupled to the regulating-valve-low-pressure chamber.

2. The apparatus of claim 1 further comprising:
a flow control valve comprising:
a flow-control-valve-high-pressure connector,
a flow-control-valve-low-pressure connector, and
a flow-control-valve-low-pressure regulator coupled to the flow-control-valve-high-pressure connector and the flow-control-valve-low-pressure connector to maintain the flow-control-valve-low-pressure connector at a user pressure;
wherein the flow-control-valve-high-pressure connector is coupled to the regulating-valve-low-pressure connector.

3. The apparatus of claim 2 further comprising:
a regulator coupled to the flow-control-valve-low-pressure connector;
wherein the regulator is selected from the group consisting of an on/off knob regulator, a push button regulator, and a demand flow regulator.

4. The apparatus of claim 3 wherein the regulating valve, the flow control valve, and the regulator are integral with each other.

5. The apparatus of claim 2 wherein the flow control valve comprises a C-10 valve.

6. An apparatus comprising:
a regulating valve comprising:
a regulating-valve-high-pressure connector,
a regulating-valve-high-pressure chamber coupled to the high-pressure connector,
a regulating-valve-low-pressure connector,
a regulating-valve-low-pressure chamber coupled to the regulating-valve-low-pressure connector, and
a regulating-valve-high-pressure regulator coupled to the regulating-valve-high-pressure chamber and the regulating-valve-low-pressure chamber to maintain the regulating-valve-low-pressure chamber at a constant pressure; and
a pressure gauge coupled to the regulating-valve-low-pressure chamber;
a flow control valve comprising:
a flow-control-valve-high-pressure chamber coupled to the low-pressure chamber of the regulating valve,
a flow-control-valve-low-pressure chamber, and
a flow-control-valve regulator coupled to the flow-control-valve-high-pressure chamber and the flow-control-valve-low-pressure chamber to maintain the flow-control- valve-low-pressure chamber at a user pressure;
wherein the regulating valve and the flow control valve are integral with each other.

7. The apparatus of claim 6 further comprising:
a flow-control-valve-low-pressure connector coupled to the flow-control-valve-low-pressure chamber.

8. The apparatus of claim 6 further comprising:
a regulator coupled to the flow-control-valve-low-pressure chamber;
wherein the regulator is selected from the group consisting of an on/off knob regulator, a push button regulator, and a demand flow regulator; and
wherein the regulating valve, the low-pressure regulator, and the regulator are integral with each other.

9. An apparatus comprising:
a regulating valve comprising:
a regulating-valve-high-pressure connector,
a regulating-valve-high-pressure chamber coupled to the regulating-valve-high-pressure connector,
a regulating-valve-low-pressure connector,
a regulating-valve-low-pressure chamber coupled to the regulating-valve-low-pressure connector, and
a regulating-valve-high-pressure regulator coupled to the regulating-valve-high-pressure chamber and the regulating-valve-low-pressure chamber to maintain the low- pressure chamber at a constant pressure; and
a pressure gauge coupled to the regulating-valve-low-pressure chamber;
a flow control valve comprising:
a flow-control-valve-high-pressure chamber coupled to the regulating-valve-low-pressure chamber,
a flow-control-valve-low-pressure chamber, and
flow-control-valve-low-pressure regulator coupled to the flow-control-valve-high-pressure chamber and the flow-control-valve-low-pressure chamber to maintain the flow-control-valve-low-pressure connector at a user pressure;
a regulator coupled to the flow-control-valve-low-pressure connector;
wherein the regulator is selected from the group consisting of an on/off knob regulator, a push button regulator, and a demand flow regulator; and
wherein the regulating valve, the low-pressure regulator, and the regulator are integral with each other.

10. A method comprising:
coupling a regulating valve with a pressure gauge to a high-pressure pressure bottle; and
displaying a pressure on the gauge equivalent to that of a low-pressure pressure bottle until the pressure in the high-pressure pressure bottle falls to that of the low-pressure pressure bottle.

11. The method of claim 10 wherein:
the high-pressure pressure bottle comprises an 1800 psi pressure bottle; and
the low-pressure pressure bottle comprises a 1000 psi pressure bottle.
